(19) United States
(12) Patent Application Publication
(10) Pub. No.: US 2023/0272264 A1
(43) Pub. Date: Aug. 31, 2023

(54) ENVIRONMENTALLY FRIENDLY NATURAL GAS HYDRATE INHIBITOR AND APPLICATION

(71) Applicant: DALIAN UNIVERSITY OF TECHNOLOGY, Dalian (CN)

(72) Inventors: Jiafei ZHAO, Dalian (CN); Yuxin JIA, Dalian (CN); Lei YANG, Dalian (CN); Yanzhen LIU, Dalian (CN); Lunxiang ZHANG, Dalian (CN); Yongchen SONG, Dalian (CN); Weiguo LIU, Dalian (CN); Yanghui LI, Dalian (CN); Yu LIU, Dalian (CN); Mingjun YANG, Dalian (CN); Zheng LING, Dalian (CN); Dayong WANG, Dalian (CN); Xiang SUN, Dalian (CN); Tao YU, Dalian (CN)

(21) Appl. No.: 17/919,077

(22) PCT Filed: Dec. 28, 2021
(86) PCT No.: PCT/CN2021/142036

§ 371 Date: Oct. 14, 2022

(51) Int. Cl. C09K 8/524

(52) U.S. Cl. CPC C09K 8/524; C09K 2208/22

(57) ABSTRACT

The present invention belongs to the technical field of natural gas hydrates (NGHs), and provides an environmentally friendly NGH inhibitor and application. The hydrate inhibitor has a component of nisin, and further comprises chitooligosaccharide and an alcohol thermodynamic hydrate inhibitor, that can enhance the thermostability of the inhibitor and the inhibitory effect for NGHs. The optimal application conditions of the NGH inhibitor of the present invention are: temperatures of −10 to 100° C., pressures of 0.1 to 25 MPa, and a maximum subcooling degree of 12° C. The inhibitor of the present invention has good NGH inhibitory performance and certain antibacterial effects, which is a low-dose, degradable, high temperature resistant, green, environmental protective, safe and efficient NGH inhibitor, that can be used for the fields of oil-gas transportation and NGHs, and provides a new solution for field application of green natural hydrate inhibitors.

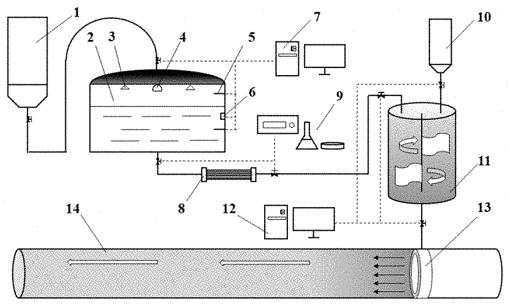

### TECHNICAL FIELD

The present invention belongs to the technical field of natural gas hydrates, and relates to an environmentally friendly natural gas hydrate inhibitor and application.

### BACKGROUND

Natural gas hydrate (NGH) is a white crystalline compound with a shape similar to ice, formed by hydrocarbon gas molecules (mainly methane) and water molecules under certain conditions. In the oil-gas production and transportation process, the hydrate formed by natural gas in pipeline environments with low temperature and high pressure is easy to cause the blockage of equipment such as production and transportation pipelines or exploitation wellbores, thereby seriously interference a normal industrial production process, posing a threat to the safety of equipment and personnel and possibly causing heavy economic losses. Therefore, how to prevent and control the NGH formation in pipelines has attracted extensive attention, which is reflected in the development and application of NGH inhibitors. At present, a method of adding NGH inhibitors to the pipeline is commonly used in industry to minimize or avoid the formation of hydrates in pipelines.

According to the application fields, the NGH inhibitors mainly include thermodynamic hydrate inhibitors (THIs) and low-dose hydrate inhibitors (LDHIs). By changing the phase equilibrium boundary conditions of the hydrate, the THIs move the hydrate phase equilibrium line to a more moderate condition on the temperature-pressure diagram to avoid the formation of hydrates from the perspective of thermodynamics. Such inhibitors mainly include alcohol compounds such as methanol and ethylene glycol or salt electrolytes such as sodium chloride and calcium chloride. In practical application, to ensure the effectiveness of the inhibitors, the THIs are usually applied at a high dose of up to 40-60 wt %, which greatly increases the application cost of such inhibitors. The alcohol compounds such as methanol and ethylene glycol have strong toxicity and volatility, which are not conducive to the use, storage, transportation, recovery, personnel safety, and environmental friendliness of the inhibitors.

The LDHIs can delay the nucleation and growth of hydrate crystals, prolong the induction time of NGH formation (kinetic hydrate inhibitors, KHIs), or slow down hydrate crystal agglomeration to inhibit the formation of hydrate blockage (anti-agglomerants, AAs). Macromolecular polymers such as polyvinylpyrrolidone (PVP) and polyvinylcaprolactam (PVCap) are conventional KHIs, and the application concentration of the KHIs is usually less than 5 wt %. Although LDHIs cannot change the thermodynamic equilibrium of hydrate or avoid the formation of hydrate under the conditions of low temperature and high pressure in pipelines, the flow of pipeline fluid can take away a small amount of hydrate generated in the pipelines, so as to avoid the formation of a large amount of hydrates and blockage in a section of the pipeline. At present, the main problems in the practical application process of the KHIs are: the high synthetic cost of the macromolecular polymers, the low degradation efficiency under natural conditions, and the ease to cause environmental pollution.

Nisin is a basic metabolite of Lactococcus lactis, which is a peptide with bacteriostatic effects, and hasan inhibitory effect on most Grain-positive bacteria and spores. Nisin shows good biodegradability in the natural environment, and is relatively low in cost and not toxic to the environment or human body. As a natural bacteriostatic agent, nisin is widely used in the field of food preservatives. Nisin has the kinetic inhibitory property for the NGH, showing good thermostability under acidic conditions, and does not exhibit obvious performance losses after high-temperature treatments were performed. Chitooligosaccharides are low-molecular-weight chitosan obtained from the chitosan degraded by biological enzymes or physical and chemical technologies. It has good antibacterial activity, water solubility, biocompatibility, and biodegradability, which is widely used in the fields of food, agriculture, industry, and medicine. Chitooligosaccharide can be used as a biological protective agent to maintain the antibacterial activity and thermostability of the nisin, which also has a certain synergistic antibacterial effect.

### SUMMARY

With respect to the defects of the above NGH inhibitor technology, the present invention provides an environmentally friendly NGH inhibitor which has the effects of low-dose, easy degradation, high-temperature resistance, antibacterial activity, green, safety, and high efficiency.

The present invention is realized by the following technical solution:

A component of an environmentally friendly natural gas hydrate inhibitor is nisin.

The environmentally friendly natural gas hydrate inhibitor further comprises chitooligosaccharide and an alcohol thermodynamic hydrate inhibitor.

The mass fraction of the nisin in a system to be regulated does not exceed 5 wt %.

The chitooligosaccharide is selected from low-molecular-weight chitosan having water solubility and antibacterial activity with a molecular weight of 500-5000; and the mass fraction of the chitooligosaccharide in the system to be regulated does not exceed 1.5 wt % to provide high-temperature protection and synergistic antibacterial effects for the nisin.

The alcohol thermodynamic hydrate inhibitor is one or a mixture of more than one of methanol, ethylene glycol, glycerol, butanol, and polyethylene glycol; the mass fraction of the alcohol thermodynamic hydrate inhibitor in the system to be regulated does not exceed 3 wt % for increasing the solubility of the nisin in a solution; and the alcohol thermodynamic hydrate inhibitor performs a synergistic effect to improve the inhibitory effect of the hydrate inhibitor of the present invention.

An application of the environmentally friendly natural gas hydrate inhibitor in oil-gas transportation and natural gas hydrate is provided. The natural gas hydrate inhibitor is applied under the conditions of absolute pressures of 0.1 to 25 MPa, temperatures of -10 to 100° C., and a maximum subcooling degree of 12° C.

Compared with the prior art, the present invention has the following beneficial effects:

The environmentally friendly NGH inhibitor and the complex inhibitor provided by the present invention have good NGH inhibitory performance, which can effectively prolong the induction time of hydrate nucleation, slow down the formation rate of the NGH, significantly reduce the formation amount of the hydrate, and greatly reduce the amount of conventional alcohol THIs. The hydrate inhibitor and the complex inhibitor take the nisin as the main component and have certain inhibitory effects on common bacteria in oil-gas transportation pipelines and production facilities. The chitooligosaccharide and the alcohol THIs added in the complex inhibitor can perform a synergistic effect of high-temperature protection, synergistic antibacterial activity, and hydrate inhibition. The hydrate inhibitor and the complex inhibitor provided by the present invention have the characteristics of low-dose, easy degradation, high-temperature resistance, antibacterial activity, safety, high efficiency, and environmental friendship, which provide a new solution for the field application of green natural hydrate inhibitors.

### DESCRIPTION OF DRAWINGS

The sole FIGURE is a schematic diagram of the application of the environmentally friendly NGH complex inhibitor in the present invention.

In the sole FIGURE: 1 fermentation filler system; 2 fermenter; 3 alkaline solution nozzle; 4 filler port; 5 temperature sensor; 6 pH value sensor; 7 data monitoring system; 8 membrane separation device; 9 titer determination system; 10 compounding filler system; 11 mixing container; 12 inhibitor preparation and control system; 13 annular nozzle; 14 oil-gas pipeline.

### DETAILED DESCRIPTION

Specific embodiments are described below. The following embodiments are intended only to describe implementation modes of the present invention and not to limit all the implementation modes of the present invention.

### Embodiment 1

The NGH complex inhibitor in the present invention can be prepared and applied by the method shown in the sole figure, comprising the following steps:

Step 1: establishing an NGH inhibitor production facility on a field of NGH inhibitor application demand, comprising a culture system of Lactococcus lactis, a membrane separation system, an inhibitor mixing system and an inhibitor injection system, wherein the culture system of Lactococcus lactis comprises a fermentation filler system 1, a fermenter 2 and a data monitoring system 7; the membrane separation system comprises a membrane separation device 8 and a nisin titer determination system 9; the inhibitor mixing system comprises an inhibitor compounding filler system 10, a mixing container 11 and a stirring blade; and the inhibitor injection system comprises an inhibitor compounding and control system 12 and an annular nozzle 13.

Step 2: delivering nutrients needed for the culture of Lactococcus lactis through the fermentation filler system 1, comprising 1% sucrose, 1% protein peptone, 2% potassium dihydrogen phosphate, 0.2% sodium chloride, and 0.02% magnesium sulfate; inoculating 5% Lactococcus lactis in the fermenter 2, with cultured fluid accounting for ⅔ of the total volume of the fermenter, and the cultured fluid having an initial pH value of 7; culturing by fed-batch fermentation.; pre-culturing at culture temperature of 35° C. for 24 h; continuously replenishing sucrose and water consumed by fermentation production through a feeding port 4 located at the top of the fermenter; replenishing 1 g of sucrose per liter of cultured fluid per hour; and making a rate of water replenishment consistent with an outflow rate of fermentation broth;

Step 3: collecting and recording the temperature and pH value in the fermenter in real-time, and maintaining the culture temperature of 35° C. according to the data collected by a temperature sensor 5; evenly spraying the solution of caustic soda into the fermenter from alkaline solution nozzles 3 distributed in several positions on the top of the fermenter according to the data fed back by a pH value sensor 6, so that the pH value of the cultured fluid is maintained at about 7 to prevent the local pH value of the cultured fluid from rising too much; and after full fermenting in the fermenter 2, delivering cultured fluid of Lactococcus lactis to a membrane separation device 8;

Step 4: conducting stepwise concentration-leaching treatment on the cultured fluid of Lactococcus lactis by the membrane separation device 8 formed by a microfiltration membrane (aperture of 0.2 μm) and a polysulfone hollow fiber ultrafiltration membrane (MWCO 10kDa) under maximum transmembrane pressure difference of 0.1 MPa; intercepting microorganisms and macromolecular impurity protein in the cultured fluid to obtain relatively pure nisin fermentation broth; sampling the fermentation broth, and analyzing and determining titer by an agar diffusion method in the nisin titer determination system 9, wherein nisin titer in the fermentation broth should not be less than 3500 IU/ml; and transporting the nisin fermentation broth to an inhibitor mixing container 11;

Step 5: adding chitooligosaccharide and alcohol THIs such as glycol into the inhibitor mixing container 11 through the inhibitor compounding filler system 10, with the mass fraction of the chitooligosaccharide as 1 wt % and the mass fraction of THIs as 3 wt %; making a stirring blade fully stirring in a preparation container at the tip speed of 1 m/s to evenly mix all components of the inhibitor; in the case of uninterrupted culture and continuous preparation, considering that the solution located at the bottom of the mixing container 11 is fully mixed to satisfy the composition requirements of the complex inhibitor, to prepare the NGH complex inhibitor of the present invention;

Step 6: controlling and using the prepared NGH complex inhibitor by the inhibitor compounding and control system 12 through a valve; injecting the hydrate inhibitor into a pipeline through the annular nozzle 13 arranged on the inner wall of an oil-gas pipeline 14, so that the inhibitor can uniformly act on the fluid inside the pipeline; by regulating the injection flow velocity of the inhibitor, adding the prepared NGH complex inhibitor according to a proportion of 5% of the fluid flow in the pipeline, and using the complex inhibitor under a subcooling degree less than 12° C. to realize field preparation and application of the NGH inhibitor.

### Embodiment 2

The present invention provides an environmentally friendly NGH inhibitor and a complex inhibitor. The inhibitory effect of the hydrate inhibitor on the NGH is verified in a high-pressure reactor through the following test:

The high-pressure reactor used in the test has a volume of 0.1 L and maximum bearing pressure of 10 MPa; the operating range of a water bath is −10 to 30° C.; and the rotating speed of a magnetic rotor is 200 to 300 r/min. Aqueous solutions containing the inhibitors are respectively added to the reactor according to the components shown in Table 1. To ensure that the temperature and the pressure in the reactor before the tests are beyond the phase equilibrium region of the hydrate, pure methane gas is filled to 8 MPa in the high-pressure reactor at 15° C.

TABLE 1
Solution Components in Reactor

| Stirring | Sample | | Solution |
|---|---|---|---|
| Speed | Group | Solution Components | Concentration |
| 200 rpm | S1 | Nisin | 2 wt % |
| | | Monoethylene glycol | 3 wt % |
| | S2 | Nisin | 5 wt % |
| | S3 | Nisin | 2.5 wt % |
| | S4 | Nisin | 1.25 wt % |
| | S5 | Nisin (treatment at 50° C.) | 2.5 wt % |
| | D1 | Deionized water | — |
| | D2 | PVP | 2 wt % |
| | | Monoethylene glycol | 3 wt % |
| | D3 | PVP | 5 wt % |
| 300 rpm | S6 | Nisin | 2 wt % |
| | | Monoethylene glycol | 3 wt % |
| | S7 | Nisin | 0.5 wt % |
| | | Monoethylene glycol | 1.5 wt % |
| | S8 | Nisin | 5 wt % |
| | S9 | Nisin | 2.5 wt % |
| | S10 | Nisin | 1 wt % |
| | S11 | Nisin | 0.5 wt % |
| | S12 | Nisin | 0.2 wt % |
| | S13 | Nisin | 0.1 wt % |
| | D4 | Deionized water | — |
| | D5 | PVP | 2 wt % |
| | | Monoethylene glycol | 3 wt % |

After the temperature and pressure data in the reactor are stable, the water bath is set to be cooled from 15° C. to 0.5° C. at a constant rate of 2° C./h. The duration time of a single test is 1000 min, and each group of tests is repeated for at least three times to reduce experiment talerror. Test data is shown in Table 2. T₁ is the hydrate onset time in the reactor.

TABLE 2
Performance Test Results of NGH Inhibitor

| Stirring | Sample | Total | |
|---|---|---|---|
| Speed | Group | Time/min | T₁/min |
| 200 rpm | S1 | 1000 | 365.18 |
| | S2 | | 342.48 |
| | S3 | | 299.12 |
| | S4 | | 303.78 |
| | S5 | | 335.81 |
| | D1 | | 226.36 |
| | D2 | | 335.98 |
| | D3 | | 329.63 |
| 300 rpm | S6 | 1000 | 383.01 |
| | S7 | | 363.00 |
| | S8 | | 368.16 |
| | S9 | | 367.33 |
| | S10 | | 330.63 |
| | S11 | | 350.50 |
| | S12 | | 325.46 |
| | S13 | | 262.56 |
| | D4 | | 224.70 |
| | D5 | | 398.03 |

The above test results indicate that the environmentally friendly NGH inhibitor and the application provided by the present invention have a good NGH inhibitory effect, obviously prolong the induction time of NGH nucleation compared with a pure water system, and have an inhibitory effect which exceeds polymeric KHI-PVP.

The above embodiments are only used for illustrating the feasible specific implementation modes of the present invention. The present invention is not limited to the above embodiments. Various modifications and changes made without departing from the scope of the present invention shall be included in the protection scope of the present invention.

1. An environmentally friendly natural gas hydrate inhibitor, wherein a component of the natural gas hydrate inhibitor is nisin.

2. The environmentally friendly natural gas hydrate inhibitor according to claim 1, further comprises chitooligosaccharide and an alcohol thermodynamic hydrate inhibitor.

3. An environmentally friendly natural gas hydrate complex inhibitor according to claim 1, wherein the mass fraction of the nisin in a system to be regulated does not exceed 5 wt %.

4. The environmentally friendly natural gas hydrate complex inhibitor according to claim 3, wherein the chitooligosaccharide is selected from low-molecular-weight chitosan having water solubility and antibacterial activity with a molecular weight of 500-5000; and the mass fraction of the chitooligosaccharide in the system to be regulated does not exceed 1.5 wt %.

5. The environmentally friendly natural gas hydrate complex inhibitor according to claim 1, wherein the alcohol thermodynamic hydrate inhibitor is one or a mixture of more than one of methanol, ethylene glycol, glycerol, butanol, and polyethylene glycol; and the mass fraction of the alcohol thermodynamic hydrate inhibitor in the system to be regulated does not exceed 3 wt %.

6. The environmentally friendly natural gas hydrate complex inhibitor according to claim 3, wherein the alcohol thermodynamic hydrate inhibitor is one or a mixture of more than one of methanol, ethylene glycol, glycerol, butanol, and polyethylene glycol; and the mass fraction of the alcohol thermodynamic hydrate inhibitor in the natural gas hydrate complex inhibitor does not exceed 3 wt %.

7. An application of the environmentally friendly natural gas hydrate inhibitor in oil-gas transportation and natural gas hydrate, wherein the natural gas hydrate inhibitor is applied under the conditions of absolute pressures of 0.1 to 25 MPa, temperatures of −10 to 100° C., and a maximum subcooling degree of 12° C.
